(19) United States
(12) Patent Application Publication
(10) Pub. No.: US 2012/0239468 A1
(43) Pub. Date: Sep. 20, 2012

(54) HIGH-PERFORMANCE SUPPLY FORECASTING USING OVERRIDE RULES IN DISPLAY ADVERTISING SYSTEMS

(76) Inventors: Ramana Yerneni, Cupertino, CA (US); Jayanth Anandaram, San Francisco, CA (US); Saurabh Sodani, Lone Tree, CO (US)

(21) Appl. No.: 13/051,185

(22) Filed: Mar. 18, 2011

(51) Int. Cl. G06Q 30/00

(52) U.S. Cl. 705/14.4

(57) ABSTRACT

A method, system and computer readable medium to adjust impression supply sampling weights in a display advertising environment while providing high-performance supply forecasting using trends adjustments and override rules. A forecasting system initiates the method upon submitting a campaign query (with a campaign query predicate to be matched with impression supply predicates) and a campaign query time period (specifying time-wise aspects of an advertising campaign). Upon receiving initial campaign query results (e.g. impression supply datastructure with base weights), the method proceeds to identify applicable weight adjustment rules for applying to the impression supply node, then, after accounting for trends or other time-wise aspects of the weight adjustment rule, applying the adjustment rule to the impression supply base weight of an impression supply node, resulting in at least one adjusted trend weight. Given adjusted trend weights, the forecasting system can more accurately predict future supply and pricing characteristics of the campaign.

### FIELD OF THE INVENTION

The present invention relates generally to display advertising, more specifically to the supply forecasting with override rules in display advertising systems.

### BACKGROUND OF THE INVENTION

Since the widespread acceptance of the Internet, advertising as a source of revenue has proven to be both effective and lucrative. Advertising on the Internet provides the possibility of allowing advertisers to cost-effectively reach highly specific target audiences as opposed to traditional broadcast and print advertising media that reach only broadly definable target audiences (e.g. radio listeners in the greater Memphis area).

To facilitate advertisement placement, advertiser's agents (e.g. a website operator, and/or their agents, advertising agents, ad server network providers, third-party ad delivery services, etc) may provide systems that allow the advertiser to book a number of impressions across websites that target the specified audience, where each impression corresponds to the display of an advertisement to an Internet user. For example, the system may enable an advertiser to book 1 million impressions that target “males, living in California”. These impressions may then be allocated across several websites that seek to attract “males living in California”.

In guaranteed display advertising, advertisers can buy guaranteed delivery contracts that specify targeted user visits (e.g. Males in California who visit Sports pages), a future duration for the contract (e.g. June-August 2012), and the number of user visits they are interested in obtaining (e.g. 100 million), where Internet publishers guarantee these contracts months in advance of the delivery date. Guaranteed display advertising is a multi-billion dollar industry and thus, intelligent pricing of guaranteed delivery contracts has a direct impact on publishers' revenue.

Unfortunately, the problem of intelligent forecasting of guaranteed delivery contracts in online display advertising exhibits at least two characteristics that, when taken together, render legacy forecasting methods inadequate. First, legacy forecasting methods treat future time too linearly (e.g. 100,000 impressions available next month, 300,000 impressions available next quarter). Secondly, the supply inventory that can be forecasted and sold to guaranteed contracts (i.e. user visits) is dynamic (i.e. ever changing), and is very high-dimensional in nature, having hundreds of possible attributes. Thus advertisers can request a forecast for any of the potentially trillions of combinations of these attributes. Consequently, traditional forecasting techniques have proven to be inadequate for solving problems of this sort.

Accordingly, there exists a need for techniques for overcoming the abovementioned and other limitations in order to achieve high-performance supply forecasting when using override rules in display advertising systems.

### SUMMARY OF THE INVENTION

A method, system and computer readable medium to adjust impression supply sampling weights in a display advertising environment while providing high-performance supply forecasting using time-wise trends, sampling weight adjustments, and other aspects of override rules. A forecasting system initiates the method upon submitting a campaign query (where a campaign query predicate is to be matched with impression supply predicates) and a campaign query time period (specifying time-wise aspects of an advertising campaign). Upon receiving initial campaign query results (e.g. impression supply datastructures having base weights), the method proceeds to identify applicable weight adjustment rules for applying to the impression supply node, and then, after accounting for trends or other time-wise aspects of the weight adjustment rule, applying the adjustment rule to the impression supply base weight of an impression supply node, resulting in at least one adjusted trend weight. Given adjusted trend weights, the forecasting system can more accurately predict future supply and pricing characteristics of a campaign.

### BRIEF DESCRIPTION OF THE DRAWINGS

The novel features of the invention are set forth in the appended claims. However, for purpose of explanation, several embodiments of the invention are set forth in the following figures:

FIG. 1A depicts an override rule data structure, according to one embodiment.

FIG. 1B depicts a weight adjustment rule data structure, according to one embodiment.

FIG. 1C depicts a weight scaling rule data structure, according to one embodiment.

FIG. 2 depicts an allocation of impression nodes to campaign queries in the form of an eligibility graph for a particular campaign query time period, according to one embodiment.

FIG. 3 depicts selected modules of an advertising server network environment including modules for high-performance supply forecasting using override rules, according to one embodiment.

FIG. 4A shows an index relating override rules to supply nodes in the form of a rule-to-impression index, according to one embodiment.

FIG. 4B shows an index relating supply nodes to override rules in the form of an impression-to-rule index, according to one embodiment.

FIG. 5 depicts a flowchart of an exemplary workflow, according to one embodiment.

FIG. 6 depicts a block diagram of a system for adjusting impression supply sampling weights in a display advertising environment, according to one embodiment.

FIG. 7 is a diagrammatic representation of a network including nodes for client computer systems, nodes for server computer systems and nodes for network infrastructure, according to some embodiments.

### DETAILED DESCRIPTION

In the following description, numerous details are set forth for purpose of explanation. However, one of ordinary skill in the art will realize that the invention may be practiced without the use of these specific details. In other instances, well-known structures and devices are shown in block diagram form in order to not obscure the description of the invention with unnecessary detail.

### DEFINITIONS

Some of the terms used in this description are defined below (in alphabetical order) for easy reference. These terms are not rigidly restricted to these definitions. A term may be further defined by the term's use in other sections of this description.

“Ad” (e.g. ad, item and/or message) means a paid announcement, as of goods or services for sale, preferably on a network such as the internet. An ad may also be referred to as an item and/or a message.

“Ad call” means a message sent by a computer to an ad server for requesting an ad to be displayed.

“Ad click-through rate” (e.g. click-through rate) means a measurement of ad clicks per a period of time.

“Ad server” is a server that is configured for serving one or more ads to user devices. An ad server is preferably controlled by a publisher of a website and/or an advertiser of online ads. A server is defined below.

“Advertiser” (e.g. messenger and/or messaging customer, etc) means an entity that is in the business of marketing a product and/or a service to users. An advertiser may include, without limitation, a seller and/or a third-party agent for the seller. An advertiser may also be referred to as a messenger and/or a messaging customer. Advertising may also be referred to as messaging.

“Advertising” means marketing a product and/or service to one or more potential consumers by using an ad. One example of advertising is publishing a sponsored search ad on a website.

“Application server” is a server that is configured for running one or more devices loaded on the application server. For example, an application server may run a device configured for deducing shadow profiles.

“Click” (e.g. ad click) means a selection of an ad impression by using a selection device such as, for example, a computer mouse or a touch-sensitive display.

“Client” means the client part of a client-server architecture. A client is typically a user device and/or an application that runs on a user device. A client typically relies on a server to perform some operations. For example, an email client is an application that enables a user to send and receive email via an email server. In this example, the computer running such an email client may also be referred to as a client.

“Conversion” (e.g. ad conversion) means a purchase of a product/service that happens as a result of a user responding to an ad and/or a coupon.

“Database” (e.g. database system, etc) means a collection of data organized in such a way that a computer program may quickly select desired pieces of the data. A database is an electronic filing system. In some instances, the term “database” is used as shorthand for a “database management system”. A database may be implemented as any type of data storage structure capable of providing for the retrieval and storage of a variety of data types. For instance, a database may include one or more accessible memory structures such as a CD-ROM, tape, digital storage library, flash drive, floppy disk, optical disk, magnetic-optical disk, erasable programmable read-only memory (EPROM), random access memory (RAM), magnetic or optical cards, etc.

“Device” means hardware, software or a combination thereof. A device may sometimes be referred to as an apparatus. Examples of a device include, without limitation, a software application such as Microsoft Word™ or a database; or hardware such as a laptop computer, a server, a display; or a computer mouse and/or a hard disk.

“Impression” (e.g. ad impression) means a delivery of an ad to a user device for viewing by a user.

“Item” means an ad, which is defined above.

“Message” means an ad, which is defined above.

“Messaging” means advertising, which is defined above.

“Network” means a connection, between any two or more computers, that permits the transmission of data. A network may be any combination of networks including, without limitation, the internet, a local area network, a wide area network, a wireless network, and/or a cellular network.

“Publisher” means an entity that publishes, on a network, a web page having content and/or ads, etc.

“Server” means a software application that provides services to other computer programs (and their users) on the same computer or on another computer or computers. A server may also refer to the physical computer that has been set aside to run a specific server application. For example, when the software Apache HTTP Server is used as the web server for a company's website, the computer running Apache may also be called the web server. Server applications may be divided among server computers over an extreme range, depending upon the workload.

“Software” means a computer program that is written in a programming language that may be used by one of ordinary skill in the art. The programming language chosen should be compatible with the computer on which the software application is to be executed and, in particular, with the operating system of that computer. Examples of suitable programming languages include, without limitation, Object Pascal, C, C++ and/or Java. Further, the functions of some embodiments, when described as a series of steps for a method, could be implemented as a series of software instructions for being operated by a processor such that the embodiments could be implemented as software, hardware, or a combination thereof. Computer-readable media are discussed in more detail in a separate section below.

“System” means a device or multiple coupled devices. A device is defined above.

“User” (e.g. consumer, etc) means an operator of a user device. A user is typically a person who seeks to acquire a product and/or service. For example, a user may be a woman who is browsing Yahoo!™ Shopping for a new cell phone to replace her current cell phone. The term “user” may also refer to a user device, depending on the context.

“User device” (e.g. computer, user computer, client and/or server, etc) means a single computer or a network of interacting computers. A user device is a computer that a user may use to communicate with other devices over a network, such as the internet. A user device is a combination of a hardware system, a software operating system, and perhaps one or more software application programs. Examples of a user device include, without limitation, a laptop computer, a palmtop computer, a smart phone, a cell phone, a mobile phone, an IBM-type personal computer (PC) having an operating system such as Microsoft Windows™, an Apple™ computer having an operating system such as MAC-OS, hardware having a JAVA-OS operating system, and/or a Sun Microsystems™ workstation having a UNIX operating system.

“Web browser” means a software program that may display text or graphics or both, from web pages on websites. Examples of a web browser include, without limitation, Mozilla Firefox™ and Microsoft Internet Explorer™.

“Web page” means documents written in a mark-up language including, without limitation, HTML (hypertext mark-up language), VRML (virtual reality modeling language), dynamic HTML, XML (extensible mark-up language), and/or other related computer languages. A web page may also refer to a collection of such documents reachable through one specific internet address and/or through one specific website. A web page may also refer to any document obtainable through a particular URL (uniform resource locator).

“Web portal” (e.g. public portal) means a website or service that offers a broad array of resources and services such as, for example, email, forums, search engines, and online shopping malls. The first web portals were online services, such as AOL, that provided access to the web. However, now, most of the traditional search engines (e.g. Yahoo!™) have transformed themselves into web portals to attract and keep a larger audience.

“Web server” is a server configured for serving at least one web page to a web browser. An example of a web server is a Yahoo!™ web server. A server is defined above.

“Website” means one or more web pages. A website preferably includes a plurality of web pages virtually connected by links or URL addresses to form a coherent group.

### Introduction to Inventory Management

Techniques for “inventory management” play key roles in display advertising systems in order to achieve a high yield for the publishers of the ad opportunities. One aspect of inventory management is the forecasting of supply/inventory to accurately ascertain the forecasted set of ad opportunities for the campaigns that are booked (or will be booked) for delivery by an ad network system. Specifically, when a new ad campaign is being planned/booked, some forecasting techniques need to determine a forecasted set of opportunities for the campaign so that the inventory management system can compute the availability of the desired supply, and then use the availability of the desired supply in determining pricing (and other) aspects of the campaign.

When a campaign is being booked, the forecasted supply for that campaign is assessed. Based on this assessed supply, the estimated number of ad opportunities that can be allocated to the campaign at hand, and the price to be charged for these opportunities, are forecasted. If the advertiser is satisfied with the forecasted supply and prices, then the campaign is booked.

As is well known, prices tend to vary in accordance with a supply versus demand relationship. Especially in situations of short supply (relative to demand), prices will increase. Such fluctuations present challenges in forecasting supply when the underlying structure of the supply (and/or demand) changes over time. For example, new sources of supply might emerge that do not have historical data. In such a case, a legacy supply forecasting model based solely on historical data would be severely handicapped due to the lack of such historical data. Forecast queries for supply related to these sources of data may underestimate significantly.

Similarly, there can be situations where previously existing sources of supply might not be present during a given time period. Again, a supply forecasting model based solely on historical data may end up overestimating the supply in such a case. In addition, there can be sporadic events, or predictable upcoming trends, or predictable changes in historical trends that cause the supply landscape to change. In some cases an accurate assessment of trends and therefore an accurate assessment of forecasts can be hard or impossible to predict based on historical trends. For example, there can be a sports event or a rock concert that may increase the traffic of certain web sites dramatically, and if the forecasting system is unaware of the impact of the event on supply, the forecasting system may underestimate the supply. Especially, the forecasting system may underestimate the supply with respect to the time period of the event.

### The Override Rule Concept

Strictly as an example, an advertising market (with multiple, competing advertisers) might be based on forecasted availability of supply corresponding to 28 million sports fans in February, and a market price might be stable, and remain stable in the absence of significant fluctuations in supply or demand. However, supply or demand might fluctuate significantly during any time period. Continuing this example, if some event were to occur in February, say the Super Bowl, the supply of say, sports fans, might indeed vary significantly. Similarly, the demand might vary significantly as advertisers might be willing to compete to reach the spike in supply of sports fans.

Forecasting techniques that take into account such fluctuations represent an improvement over legacy forecasting systems. One way to model the aforementioned fluctuations is to consider the fluctuation as a time-wise perturbation of (for example) an otherwise smooth function. And in such a case, a rule (e.g. an override rule) can be defined to overlay the otherwise smooth function. Returning to the previous example, while there might be a supply of 28 million sports fans in February, it might also be true that on Super Bowl Sunday, the supply swells to 98 million sports fans on just that day, Super Bowl Sunday, and roughly one million sports fans on every other day in February. Such a perturbation can be defined in an override rule. As used herein, an override rule includes:
An override rule ID,
A description of the supply to which the rule can be applied,
A description of the time-wise applicability of the overrise rule, and
An action to be taken.

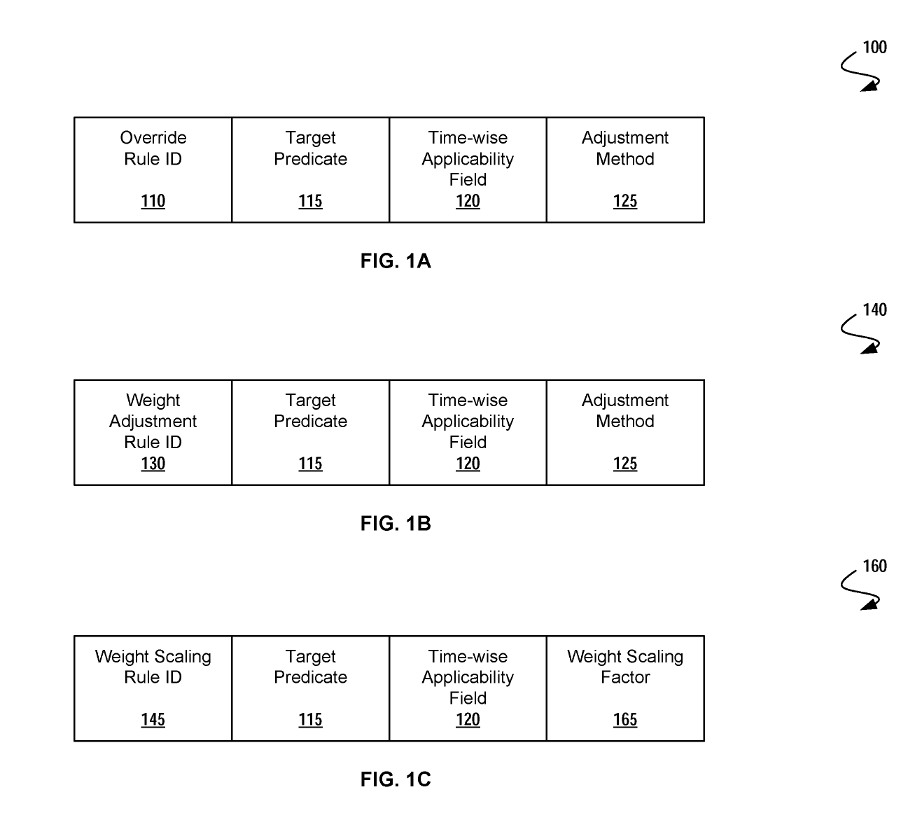

FIG. 1A depicts an override rule data structure. As shown, one field serves to hold an override rule ID 110. Such an ID can be a number, or a code, or a hash value, or any other representation, including any of a variety of forms of human-readable representations such as “R1”, “R2”, “R3”, etc. Such an override rule data structure 100 can be used in the context of overriding any one or more characteristics of a function or trend. For example, an override rule data structure 100, and specifically the fields therein, can be used for adjusting the value of a function or trend by application of an adjustment method. An override rule can be specified as shown in Table 1.

TABLE 1
Possible override rule data structure field descriptions

| Field Statement | Field Description |
|---|---|
| An override rule ID | An override rule ID 110 |
| A description of the supply to which | A target predicate 115 |
| the rule can be applied | |
| A description of the time-wise | A time-wise applicability field 120 |
| applicability of the override rule, and | |
| An action to be taken | An adjustment method 125 |

In the above example, the override rule ID 110 can be “R1”, the target predicate 115 can be “sports fans”, the time-wise applicability field 120 can reference “only on Super Bowl Sunday”, and the adjustment method 125 can be “add 70 million impressions”.

Of course, the foregoing is merely an example, and myriad other override rules are reasonable. Indeed, a reasonable commercial embodiment of high-performance supply forecasting using override rules in display advertising systems might employ hundreds, or thousands, or hundreds of thousands (or more) override rules. Moreover, the foregoing adjustment method (i.e. can be “Add 70 million impressions”) can be any arbitrary method, such as “scale by a factor of 2”, or “multiply sample weight by a scale factor of 0.5”, or “double the volume between Feb. 10, 2011 and Feb. 14, 2011”, etc.

Advertising network participants, especially sources of supply (e.g. website publishers, ad aggregators, etc) can create override rules that can help the inventory management function to adjust its estimates of forecasted supply. These rules can be used for existing websites/pages as well as new websites/pages. For example, say a publisher launches a new website; the publisher may create an override rule based on an initial estimate of the traffic for the site. Such estimates may be derived from other similar sites. For example, the publisher may indicate that the traffic for the new website/page is 50 million ad opportunities in total for the next one month. After the first month, the forecasting engine may have constructed a model based on the actual traffic observed over that month so that it can predict (possibly using sampling techniques) the estimated supply from that source going forward. Indeed, many of the embodiments described herein combine uses of override rules with sample-based forecasting.

### Introduction to Supply Forecasting Based on Sampling

When the number of forecasted ad opportunities for an ad campaign is very large (i.e. of the order of hundreds of millions of opportunities), computing availability and pricing information based on such a large number of items is extremely compute-intensive. Accordingly, some display advertising systems employ sampling techniques to efficiently represent a set of forecasted ad opportunities in a compact manner. Each sample carries a weight such that the sum of the weights of the constituent samples, making up a set of samples, adds up to the total number of forecasted impressions represented by the set of samples.

Conceptually, pricing a contract based on forecasted supply attempts to estimate the supply based on the likelihood that individual user visits (i.e. corresponding to a particular demograph) can be delivered to the contract. However, considering forecasting based on specific demographs can introduce the problem of dealing with trillions of overlapping units of supply. That is, the demograph of “males in California” might overlap the demograph of “males between ages of 24 and 32”. Using known sampling techniques, the set of user visits that are eligible (by virtue of the user's demographics) to be served an advertisement corresponding to the contract can be modeled as a “weight”. Using such sampling techniques, the overlap and intersection between the various products is ‘built in’ to the weight model.

As an example, consider forecasting the likelihood of fulfilling a contract that targets “Sports Fans living in Chicago”, or “Auto Racing Enthusiasts living in Illinois”. A sampling technique might forecast supply for this contract based on two weighted samples. That is, if the sample technique reported twice as many “Sports Fans living in Chicago” (e.g. 4 million) as were reported “Auto Racing Enthusiasts living in Illinois” (e.g. 2 million), then a demand contract for say 1 million impressions might be booked, with the expectation that the ads might be presented to future user visits will be randomly drawn from the pool “Sports Fans living in Chicago” twice as often as will be drawn from the pool “Auto Racing Enthusiasts living in Illinois”.

Combining Sample-Based Forecasting with Override Rules

In exemplary embodiments, an inventory management system processes override rules that specify adjustments to the amounts of forecasted supply. In such embodiments, the inventory management system adjusts the weights of the supply samples based on the adjustment method that applies to that sample. For example, consider the following three override rules: one override rule R1 to be applied to supply source S1 indicating a 10% increase in supply, a second override rule R2 to be applied to supply source S2 indicating a 10% decrease in supply, and a third override rule R3 to be applied to supply source S3 indicating a 25% increase in supply. And, when also considering that the supply is determined using the aforementioned sampling technique then, using a supply node having a sampled base weight of 1000, if the sample is an ad opportunity from source S1, its weight is increased to 1100; if it is from source S2, its weight is decreased to 900; if it is from source S3, its weight is increased to 1250.

In order to preserve sufficient accuracy in the booking process, some embodiments process a relatively large number of samples (i.e. of the order of hundreds of thousands). Also, there can be quite a few override rules in a large-scale display advertising system (hundreds or even thousands). Yet, in a regime that applies override rules to samples of supply, the management system processes need to consider each of the samples that match the campaign query and adjust its weighting by considering the applicability of each of the override rules. Accordingly, the forecasting engine has a performance challenge. The performance challenge can translate to high latency for the campaign query at hand, and can also lead to problems caused by consuming a great deal of system computing resources, which problems can adversely affect the latency of other concurrently-executing campaign queries. Still further, determining which samples match the campaign query, and which rules are applicable to which samples, and which rules are time-wise applicable to which samples present still further performance challenges.

FIG. 1B depicts a weight adjustment rule data structure. As shown one field serves to hold a weight adjustment rule ID 130. Such an ID can be a number, or a code, or a hash value or any other representation, including any of a variety of forms of human-readable representations such as “R1”, “R2”, “R3”, etc. Such a weight adjustment rule data structure 140 can be used in the context of overriding any one or more characteristics of a function or trend. For example, a weight adjustment rule data structure 140 may contains fields that can be used to adjust the value of a function or trend by application of an adjustment method 125. Further, a weight adjustment rule data structure 140 can include a target predicate 115 (e.g. “interest=Sports”), and a time-wise applicability field 120 (e.g. on Feb. 6, 2011). A target predicate 115 is a logical expression, and can be arbitrarily complex, possibly including a compound logical predicate (e.g. “interest=Sports” AND “gender=Female”). Similarly, a time-wise applicability field 120 can be arbitrarily simple (e.g. during the month of February 2011) or more complex (on Feb. 2, 2011, Mar. 20, 2011, and Jun. 10, 2011-Jul. 21, 2011), or still even more complex, possibly involving a specification language and/or a taxonomy. In some embodiments, the time-wise applicability field 120 is a complex data type, possibly characterizing applicability to any level of time-wise granularity.

FIG. 1C depicts a weight scaling rule data structure 160. As shown one field serves to hold a weight scaling rule ID 145. Such an ID can be a number, or a code, or a hash value or any other representation, including any of a variety of forms of human-readable representations such as “R1”, “R2”, “R3”, etc. Such a weight scaling rule data structure 160 can be used in the context of overriding any one or more characteristics of a function or trend. For example, a weight scaling rule data structure 160, specifically the fields therein, can be used for scaling the value of a function or trend by a weight scaling factor 165.

### Introduction to Allocating Supply to Demand

In a display advertising setting, there are many ways or policies for allocating supply (e.g. an impression) to demand (e.g. a campaign query for display advertising). In one representation, pools of supply are matched to contracts in a graph. Such a matching can be calculated (e.g. for purposes of forecasting when defining a campaign), then used at a future time for serving the matched impressions to the contract or contracts of the campaign. In the context of computing an allocation plan and/or serving advertisements to impressions at serving time, errors resulting in under forecasting or over forecasting supply can introduce errors in computed allocation plans, and may negatively impact the likelihood of achieving campaign objectives. Accordingly, techniques for modeling supply with override rules serve to improve forecasting accuracy.

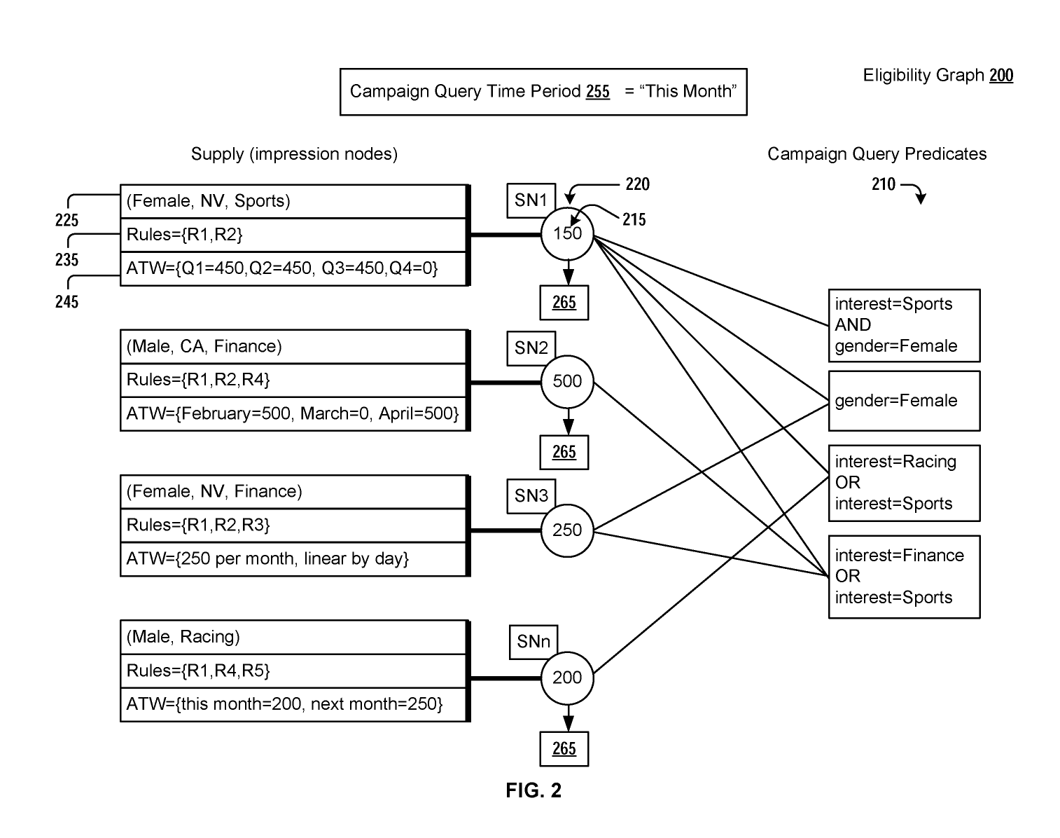

FIG. 2 depicts an allocation of impression nodes to campaign queries in the form of an eligibility graph (e.g. the eligibility graph 200) for a particular campaign query time period. More particularly, FIG. 2 depicts an allocation of supply (e.g. impression supply nodes 220) to campaign queries (e.g. as shown by the instances of campaign query predicates 210) in the form of an eligibility graph 200 for a particular campaign query time period. It should be noted that discussions herein refer to forecasting (i.e. the campaign query time period is a future time period), however, it is reasonable and envisioned that a campaign query can be a historical query (i.e. the campaign query time period is a past or historical time period).

A supply node is said to be eligible under a campaign query predicate if there is a logical intersection between the predicate of the query and the set of supply nodes corresponding to a supply predicate 225.

The left-hand vertices (depicted as circles) consist of I (i.e. a supply of impressions); the right-hand vertices (depicted as rectangles) consist of J (i.e. demand from a campaign query). The edge-set, E, consists of edges (i, j) such that i is eligible for query j. The set of user visits (i.e. supply) eligible for query j is denoted by E(j). Likewise, the set of query eligible for i is denoted by E(i). Note that the eligibility graph shows characteristics (e.g. gender, interest, etc) of a user (e.g. Female, Sports) as well as instances of supply predicates (e.g. gender=M).

Also shown within each impression supply node 220 are numeric quantities for supply impression base weight 215. Specifically, as shown, the supply of impressions, which impression supply nodes 220 are depicted as circles, are annotated with a numeric magnitude of supply. For example, a value of 150 might represent 150 thousand impressions available in a certain time period. As shown, the time period is given by a campaign query time period 255, which is specified as “This Month”. Of course any time period can be described, in any convenient terms, such as “next month”, “this year” or using a time range such as “[Jan. 1, 2011 12:00 AM-Jan. 31, 2011 11:59:59 PM]”. In exemplary embodiments, an impression supply node 220 can include a pointer to a trend time series forecast 265, and a trend time series forecast can be codified in any convenient manner. For example, a trend can be codified as a function (e.g. a time-wise linear function such as 150 thousand impressions per month), or as a discrete time series forecast (e.g. FEB=150K, MAR=150K, APR=125K), or in any other convenient form or format. Those skilled in the art can observe that, while there may be many millions or even trillions of possible different impression supply nodes 220 (e.g. referring to any arbitrarily complex predicates) a much smaller set of trends can satisfy most or all commercially relevant codifications of a trend time series forecast. The foregoing is merely illustrative, and a trend can be represented merely referring to a single period in time, as is shown with respect to supply node SN3, showing only the impression base weight given for the campaign query time period 255. It can now be understood that an impression base weight in combination with a suitable codification of a trend time series forecast 265 can be used to predict a forecast for an arbitrary future period.

Now, returning to the discussion of FIG. 1A, FIG. 1B, and FIG. 1C, any of the rules (e.g. 100, 140, 160) can include a target predicate 115. And a campaign query might seek to forecast the number of supply impressions that match a campaign query predicate. Continuing, the query results might return impression supply nodes that match the predicate of the campaign query. For example, and referring to FIG. 2, a campaign query predicate of “gender=Female” might return supply nodes SN1 (i.e. matching “Female, NV, Sports”) and SN3 (i.e. matching “Female, NV, Finance). Having supply nodes SN1 and SN3 as query results, then any rules that have a matching instance of a target predicate 115 can be candidates to be further considered for time-wise applicability.

Also shown in FIG. 2 are the annotation of a list of applicable rules 235, and the annotation of an adjusted trend weight 245, both of which are discussed infra.

### Overview of Networked Systems for Online Advertising

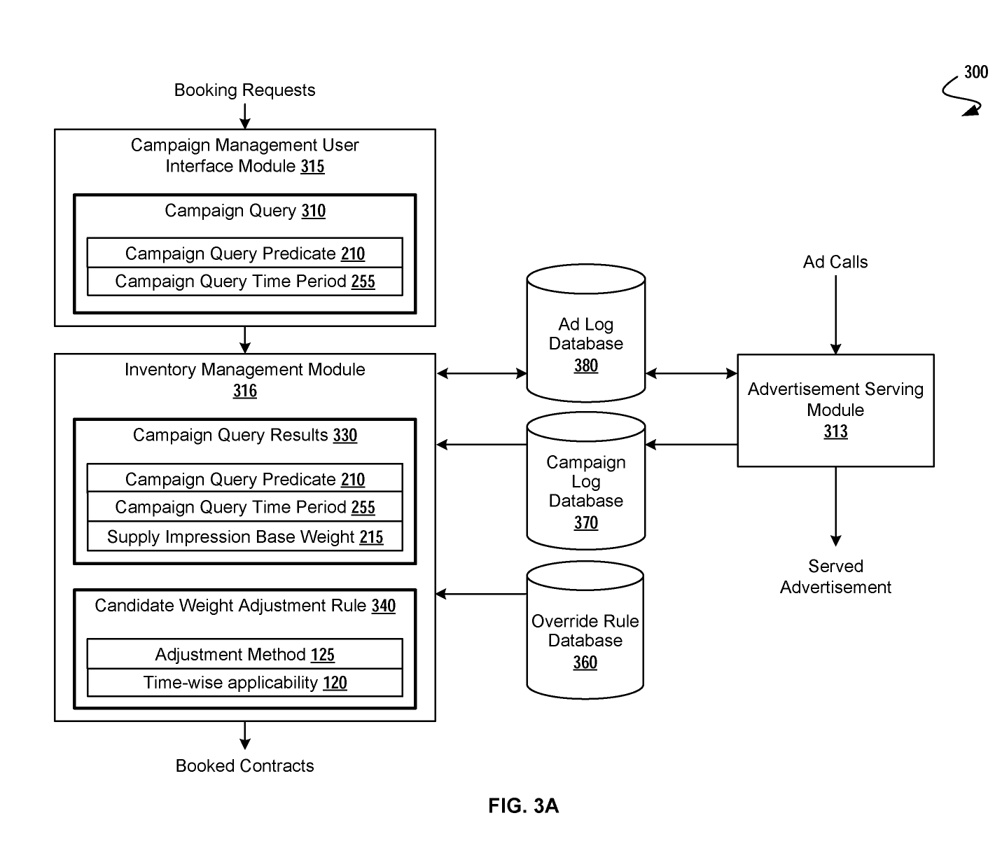

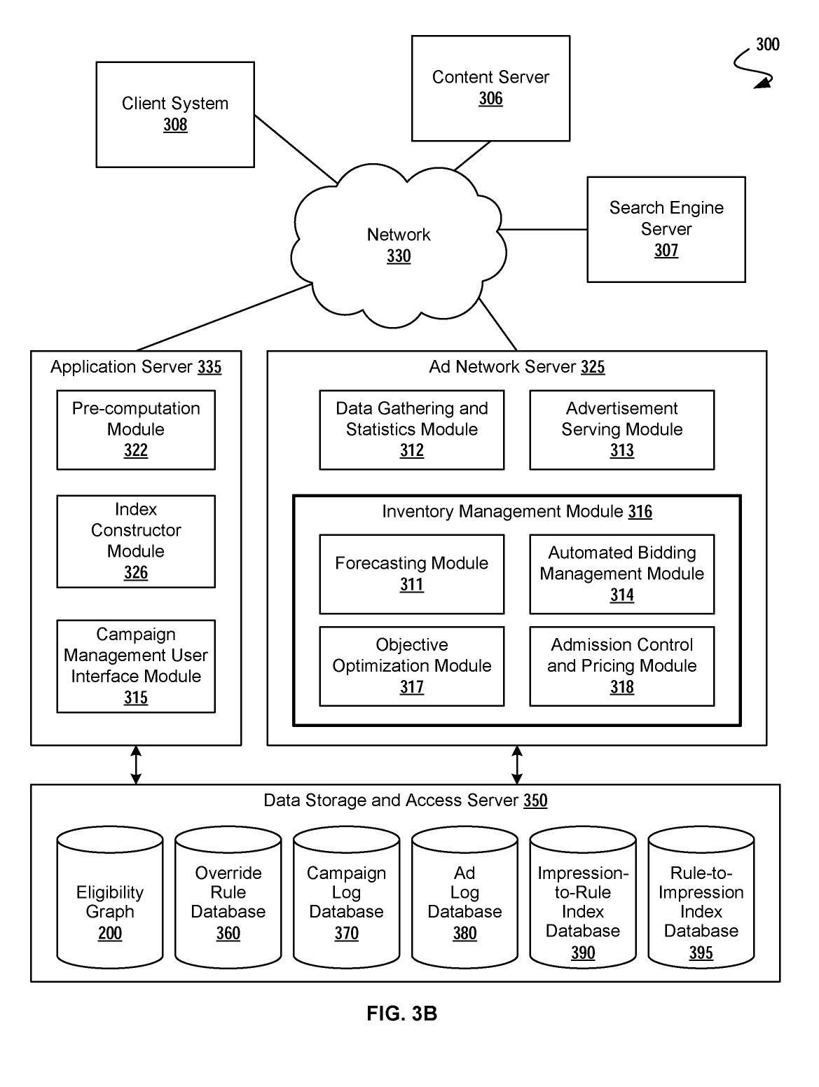

FIG. 3A depicts selected modules of an advertising server network environment 300 including modules for high-performance supply forecasting using override rules, in which some embodiments operate. In the context of advertising server network environment 300, a method for adjusting the sampling weight of an impression supply node can be practiced. As shown, practice of the method commences when a user interfaces with a campaign management user interface module 315, which user interface module therefrom the user can specify a campaign query 310. For example, the user might want to target “sports fans” (or any other campaign query predicate) during February 2011 (or any other campaign query time period). Having formed a campaign query then, the user might seek to determine pricing aspects (and other aspects) of such a campaign by submitting the user's campaign query (with the campaign query predicate 210 and with the campaign query time period 255) in expectation of receiving one or more instances of campaign query results 330, the campaign query results 330 comprising characterizations of one or more supply impression pools, and the pools having base weights (e.g. a number of impressions forecasted to be available during the specified time period).

For dealing with special conditions or events such as Super Bowl Sunday, an inventory management module 316 might check an override rule database 360 for candidate-applicable rules. In some cases the override rule database 360 can return many candidate applicable rules, and further processing might be performed to normalize or reject the candidate rule from consideration. Once processing has identified an applicable, normalized (i.e. not rejected) candidate applicable weight adjustment rule 340, the adjustment method of the rule can be applied to the supply impression base weight 215. For example, if the supply impression base weight indicates a supply of 28 million sports fans in February, and the normalized (i.e. not rejected) candidate applicable weight adjustment rule 340 indicates to add 70 million impressions on Super Bowl Sunday, then the base weight is so adjusted, thus accounting for the time-wise nature (e.g. one day only, on Super Bowl Sunday) of the weight adjustment.

As becomes apparent from the foregoing example, the notion of a base weight can include the notion of time, such that a base weight can be considered as a function of time. As is earlier indicated, the notion of time can be captured using any well-known techniques. For example, base weight can refer to a month (as in the previous example), or it can refer to a single day, or any other time period for that matter. Moreover, variation of a base weight over time can be captured as a series of time-separated values, or variations of a base weight over time can be captured as a function of time. Table 2 provides some examples.

TABLE 2
Possible time window representations

| Exemplary Time Description | Exemplary Representation |
|---|---|
| Impression weights by month | {Jan = 100, Feb = 200, Mar = 300} |
| Impression weights by specific day | Feb. 6, 2011 = add 70 million |
| Impression weights variation by | Weight = 3 D + 1 million |
| day | (D = days after Feb. 6, 2011) |
| Impression weights by day | {10k, 20k, 30k, 31k, 32k, . . . } |
| | beginning Feb. 6, 2011 |

Also shown in FIG. 3A, the advertising server network environment 300 is an advertisement serving module 313, which module can receive an ad call and, in response, serve one or more advertisements. Such an event can be captured, and stored in an ad log database 380 and/or a campaign log database 370. In some embodiments, the ad log database 380 and/or the campaign log database 370 are used by the inventory management module 316.

FIG. 3B depicts an advertising server network environment including modules for high-performance supply forecasting using override rules in display advertising systems, in which some embodiments operate. In the context of internet advertising, placement of advertisements within an internet environment using an advertising server network has become common (e.g. using servers within an advertising server network environments 300). An internet advertiser may enter into a advertising campaign (including one or more delivery contracts) such that whenever any internet user satisfying the terms of the delivery contract visits a web page (e.g. via a client system 308) the advertising system can deem the visit as an opportunity for displaying an impression, and can render the web page with an advertisement as per the terms of the delivery contract. In some cases, the web page may be associated with a particular property, and the user may have traversed to the particular property using a search engine server 307. Continuing, the advertisement is composited on a web page by one or more servers (e.g. an ad network server 325, a content server 306, an application server 335, etc) for delivery to a client system 308 over a network 330. Given this generalized delivery model, and using techniques disclosed herein, sophisticated online advertising might be practiced. More particularly, an advertising campaign might include highly-customized advertisements delivered to a user corresponding to highly-specific target predicates, which highly-specific target predicates may correspond to a delivery contract that was booked on the basis of a forecast resulting from a query involving one or more intersecting campaign query predicates (e.g. a forecast resulting from one or more instances of a campaign query predicate 210).

Again referring to FIG. 3B, an internet property (e.g. a publisher hosting the publisher's base content on a content server 306) might be able to measure the number of visitors that have any arbitrary characteristic, demographic, target predicates, or attributes, possibly using an ad network server 325 in conjunction with a data gathering and statistics module 312. Thus, an internet user might be ‘known’ in quite some detail as pertains to a wide range of target predicates or other attributes, and traffic capturing such target predicates or other attributes can be used in creating a campaign log database 370 and an ad log database 380.

In embodiments of the systems within an advertising server network environment 300, components of the ad network server can perform processing such that, given an advertisement opportunity (e.g. an instance of an impression from impression supply node 220), an advertisement serving module 313 determines which (if any) contract(s) match the advertisement opportunity. More particularly, an advertisement serving module 313 can use an allocation plan (not shown), which allocation plan can, in turn, result from processing an eligibility graph 200, possibly using a network flow solver (not shown). The data storage and access server 350 can host any one or more databases. For example, data storage and access server 350 can host an eligibility graph 200, an override rule database 360, a campaign log database 370, an ad log database 380, an impression-to-rule index database 390, and a rule-to-impression index database 395. As shown, the application server 335 can host a plurality of modules and data structures, for example a pre-computation module 322 and/or an index constructor module 326.

In some embodiments, the advertising server network environment 300 might host an inventory management module 316, which in turn can cooperatively communicate with, or assemble a variety of modules to serve as management and control operations (e.g. an objective optimization module 317, a forecasting module 311, an automated bidding management module 314, an admission control and pricing module 318, a campaign management user interface module 315, etc) pertinent to defining and managing campaigns and for supporting the serving of advertisements to users. In particular, the modules, network links, algorithms, assignment techniques, serving policies, and data structures embodied within the advertising server network environment 300 might be specialized so as to perform a particular function or group of functions reliably while observing capacity and performance requirements.

Now, returning to the latter part of the discussion of FIG. 3A, it becomes apparent that the applicability of an override rule (e.g. a weight adjustment rule) can be determined using two different criteria, based on the answers to the following questions:
Does the override rule apply, predicate-wise, to the supply impression(s) returned from the campaign query? For example, if the campaign query sought to forecast the availability of supply using the predicate “sports fans”, an override rule with the target predicate “sports fans” can be deemed to apply predicate-wise. Of course, the foregoing example is merely an example, and other predicate-wise applicability formats, including compound predicates, are reasonable and envisioned.
Does the override rule apply, time-wise, to the supply impression(s) returned from the campaign query? For example, if the campaign query sought to forecast the availability of supply for “sports fans” in “February 2011”, an override rule with the time-wise applicability “Super Bowl Sunday 2011” can be deemed to apply time-wise (since “Super Bowl Sunday 2011” is within “February 2011”). Of course, the foregoing example is merely an example, and other time-wise applicability formats are reasonable and envisioned.

Now, given that advertisers can request a forecast for any of the potentially trillions of combinations of predicates and time periods, implementation of an advertising server network environment 300, might divide processing into two groups of processes, namely batch (or offline) processing, and interactive (or on-line) processing. Strictly as an example, Table 3 describes one possible division of processing between batch processing and interactive processing.

TABLE 3
Possible division of processing

| Batch/Off-line Processing | Interactive/On-line Processing |
|---|---|
| Determine and annotate which | Process Campaign Queries |
| override rules apply predicate-wise | |
| to which supply nodes | |
| Create an index for retrieving a list | Determine which annotated override |
| of rules, based on a target predicate | rules are time-wise-applicable (e.g. |
| | using a time-wise applicability field |
| | 120) to the impression supply nodes |
| | returned by a campaign query |
| Create an index | Apply an adjustment method to |
| | inventory supply nodes |

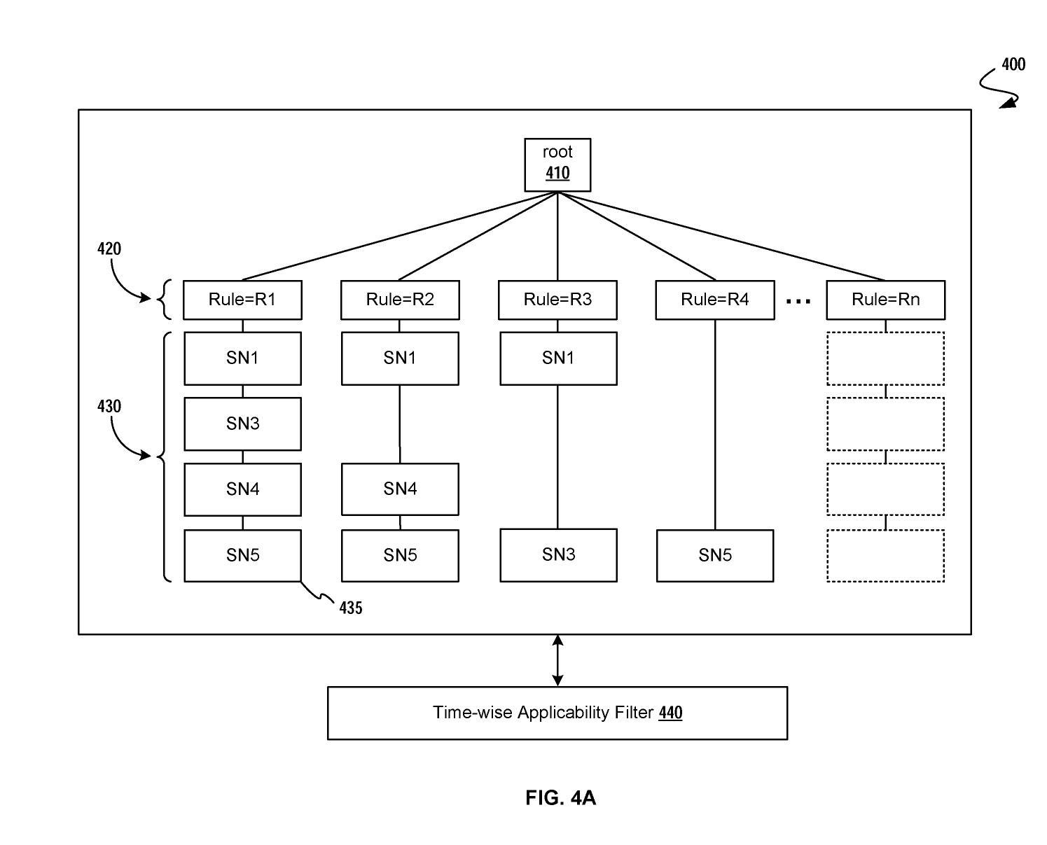

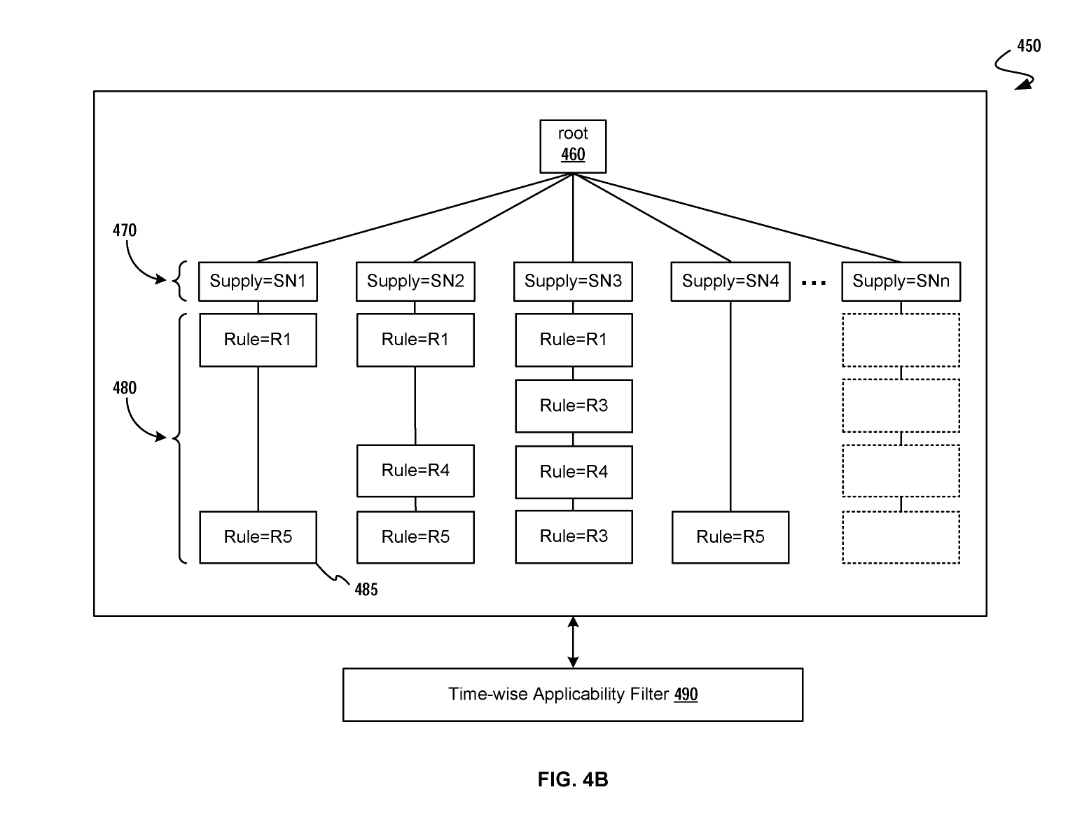

In one embodiment, the predicate-wise override rule applicability can be annotated onto the supply impression node(s) returned from the campaign query. For example, and as shown in FIG. 2, an impression supply node can be annotated with a list of applicable rules 235. In another embodiment the predicate-wise override rule applicability to a supply node pool can be captured in an impression-to-rule index (see FIG. 4B, below) and then annotated onto the supply impression(s) returned from the campaign query. Table 3 highlights possibilities employing a batch/off-line/pre-computation approach that allows the override rules to be partially processed off-line. The results of such pre-computation includes derived data and indexes that are set up for subsequent supply forecast processing (e.g. by a forecasting module 311) or for subsequent campaign management processing (e.g. by a campaign management user interface module 315) during the “online” computation when a campaign query is being processed. Any or all of the batch/off-line/pre-computation processing can be accomplished within the context of an advertising server network environment 300 using a pre-computation module 322.

In some cases, the pre-computation does not know a priori what can be the full range of descriptions within a time-wise applicability field 120, so one approach is to consider the campaign duration (a future time window) that is specified when the query is processed. The time-wise duration is then used in determining which override rules apply time-wise to the sample ad opportunities for the campaign queries. To address this challenge, herein are disclosed techniques to aggregate and partially derive the adjustment factors for the sample ad opportunities that are sensitive to the time windows for those opportunities in a specified forecasting horizon. Specifically, one technique computes indexes (e.g. bit vector indexes) of sample ad opportunities for each override rule. Another technique inverts these indexes to identify, for a given sample ad opportunity, the set of override rules that apply to it.

FIG. 4A shows an index relating override rules to supply nodes in the form of a rule-to-impression index 400. As an option, the inverted index may be implemented in the context of the architecture and functionality of the embodiments described herein. Of course, however, the rule-to-impression index 400 or any portion therefrom may be used in any desired environment. In the context of high-performance supply forecasting using override rules in display advertising systems, embodiments can use a rule-to-impression index 400 for determining if an an impression supply node could be subjected to (is applicable to) a particular override rule (e.g. a weight adjustment rule, a weight scaling rule, etc). Some embodiments implement a service for performing rule-to-supply applicability checks by using an inverted index in the form of a rule-to-impression index 400, and many techniques exist for constructing an inverted index (e.g. using an index constructor module 326).

As shown, a rule-to-impression index 400 includes a tree structure stemming from an inverted index root 410 into the inverted index branches 420 (labeled as Rule=R1, Rule=R2, . . . Rule=Rn) under which inverted index branches 420 are supply nodes 430. In some embodiments, the corresponding supply nodes 430 are labeled with a supply node ID (e.g. SN1, SN3, etc), which supply nodes can be used for indicating one or more impression supply nodes that might be predicate-wise applicable (e.g. matched, at least in part) with respect to the target predicate 115 of the rule in its inverted index branch 420. For example, the index supply node 435, (i.e. supply node SN5) might be predicate-wise subjected to (at least in part) rule R1. Another embodiment includes creating a rule-oriented bit-vector index. Of course, the foregoing structures are only illustrative examples, and other structures are reasonable and envisioned. Thus, it can be understood that, using a rule-to-impression index 400 (or other rule-to-supply applicability matching technique), a particular rule can be matched to any number of supply nodes, or it can be determined that a particular rule is not matched to any supply nodes.

While the foregoing has emphasized predicate-wise rule-to-supply applicability matching techniques, also disclosed is a step for time-wise rule-to-supply applicability matching. As shown, the rule-to-impression index 400 includes a facility to filter based on time-wise applicability, possibly using a time-wise applicability filter 440. Such a filter can determine if there is any time-wise overlap between any of the periods of the impression supply nodes and the value given in the time-wise applicability field 120 of the rule, and then the time-wise applicability of the rule can be projected onto the periods of the impression supply nodes. For example, the projection of “Super Bowl Sunday 2011” would overlap (ostensibly by one day) the period “February 2011”, As a further example, the projection of the quarter-long period “Calendar Q1, 2011” would overlap (by one month) the period “February 2011”. In another example, the projection of “Nov. 11, 2011” (e.g. form a rule) would not overlap the period “February 2011” (e.g. from an impression supply node) and, in such a case, various embodiments would not apply that rule to calculate an adjusted trend weight.

FIG. 4B shows an index relating supply nodes to override rules in the form of an impression-to-rule index 450. As an option, the inverted index may be implemented in the context of the architecture and functionality of the embodiments described herein. Of course, however, the impression-to-rule index 450 or any portion therefrom may be used in any desired environment. In the context of high-performance supply forecasting using override rules in display advertising systems, embodiments can use an impression-to-rule index 450 for determining if an override rule (e.g. a weight adjustment rule, a weight scaling rule, etc) is applicable to an impression supply node. Some embodiments implement a service for performing impression-to-rule applicability checks by using an inverted index in the form of an impression-to-rule index 450. Many technique exist for constructing an inverted index (e.g. using an index constructor module 326). As shown, a supply-oriented impression-to-rule index 450 includes a tree structure stemming from an inverted index root 460 into the inverted index branches 470 (labeled as Supply=SN1, Supply=SN2, . . . Supply=SNn) under which inverted index branches 470 are override rules 480. In some embodiments, the corresponding rules are labeled with a Rule ID, or weight adjustment rule ID, or weight scaling rule ID (e.g. R1, R5, etc), which can be used for indicating one or more override rules that might be predicate-wise applicable (e.g. matched, at least in part) with respect to the impression supply node in its inverted index branch 470. For example, the rule R5 485 might be predicate-wise applicable to (at least in part) rule index supply node SN1.

Another embodiment includes creating a supply-oriented bit-vector index. Yet other embodiments include creating/re-creating the impression-to-rule index on a reoccurring schedule. For example, the impression-to-rule index can be recreated on a periodic schedule (e.g. hourly, daily, weekly, etc.), or, the impression-to-rule index can be recreated on an event-driven basis (e.g. upon a change affecting impression inventory, upon a change affecting one or more override rules, etc.). Of course, the foregoing structures are only illustrative examples, and other structures are reasonable and envisioned.

Thus, it can be understood that, using an impression-to-rule index (or other supply-to-rule applicability matching technique), a particular impression supply can be matched to any number of rules, or it can be determined that a particular impression supply is not matched to any rules.

While the foregoing has emphasized predicate-wise impression-to-rule applicability matching techniques, also disclosed is a step for time-wise impression-to-rule applicability matching. As shown, the impression-to-rule index 450 includes a facility to filter based on time-wise applicability, possibly using a time-wise applicability filter 490. Such a filter can determine if there is any time-wise overlap between the time-wise applicability of a rule and the period given in the impression supply nodes and, if so, the time-wise applicability of the rule can be projected onto the period given in the impression supply node. If there is an overlap, the adjustment method 125 (e.g. weight scaling factor 165) can be applied to the weight of the supply impression.

Returning to the discussion of FIG. 2, note the adjusted trend weight 245 shown to the left of supply impression base weight 215. Combining the notion of a supply impression base weight 215 (e.g. a number of impressions per a time period), and the projection of a time-wise applicability from an override rule (e.g. a scaling factor of impressions per a time period), embodiments can process a supply impression base weight projection of a time-wise applicability from an override rule by determining the time period characterized by the combination and then applying the adjustment method to create an adjusted trend weight 245. For example, and as shown, if the supply impression base weight 215 refers to a monthly volume of impressions (e.g. 150,000 impressions per month) and the time-wise applicability and adjustment method of the override rule refers to yearly quarters (e.g. “scale factor for Q4=0”), then the time period characterized might be a yearly quarter, and the projections would result in an adjusted trend weight 245 such as “ATW={Q1=450, Q2=450, Q3=450, Q4=0}”. Note that many other combinations are possible and, depending on the time periods involved and the extent of the projection overlap, can determine the form and representation of adjusted trend weight (e.g. a list of days with day-by-day weights, a list of months with month-by-month weights, etc), and techniques for deriving appropriate form and representations of time-wise accurate representations of an adjusted trend weight 245 are well known.

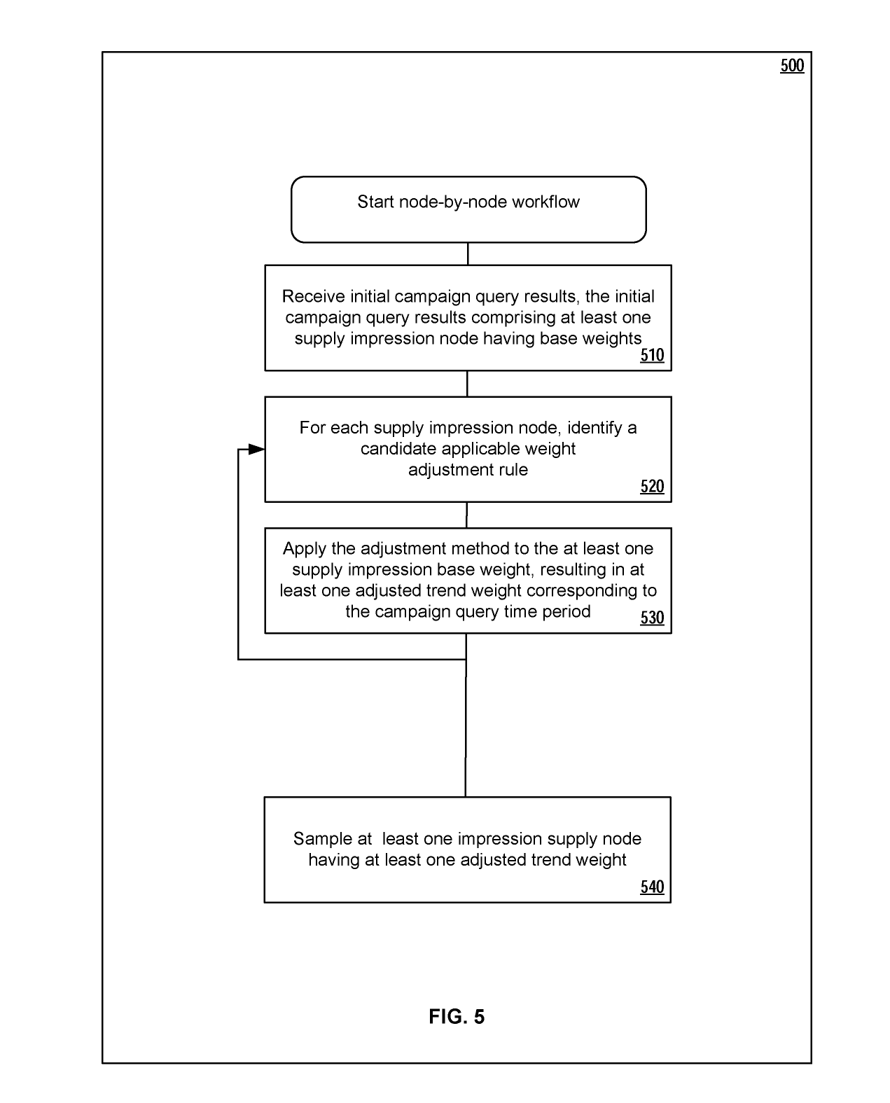

FIG. 5 depicts a flowchart of an exemplary workflow. The steps 510, 520, 530, and 540 are steps for a possible workflow, designated as the node-by-node workflow. The workflow can be entered after a step (not shown) submits a campaign query comprising at least a campaign query predicate and a campaign query time period. Then, as shown, the workflow can receive the corresponding initial campaign query results, the initial campaign query results comprising at least one impression supply node having base weights (see step 510). The received campaign query results are deemed as initial campaign query results in the sense that they have not been adjusted by the successive steps. Step 520 serves for identifying a candidate-applicable weight adjustment rule, the candidate-applicable weight adjustment rule having an adjustment method. The adjustment rule can be applied at this point in the workflow (see step 530), or the adjustment rule can be applied at a later point in the workflow. The step 530 serves for applying the adjustment method to the at least one supply impression base weight, resulting in at least one adjusted trend weight. As shown in the node-by-node workflow, the step 530 is performed in a loop, successively applying the adjustment method to the successive supply nodes as per step 520.

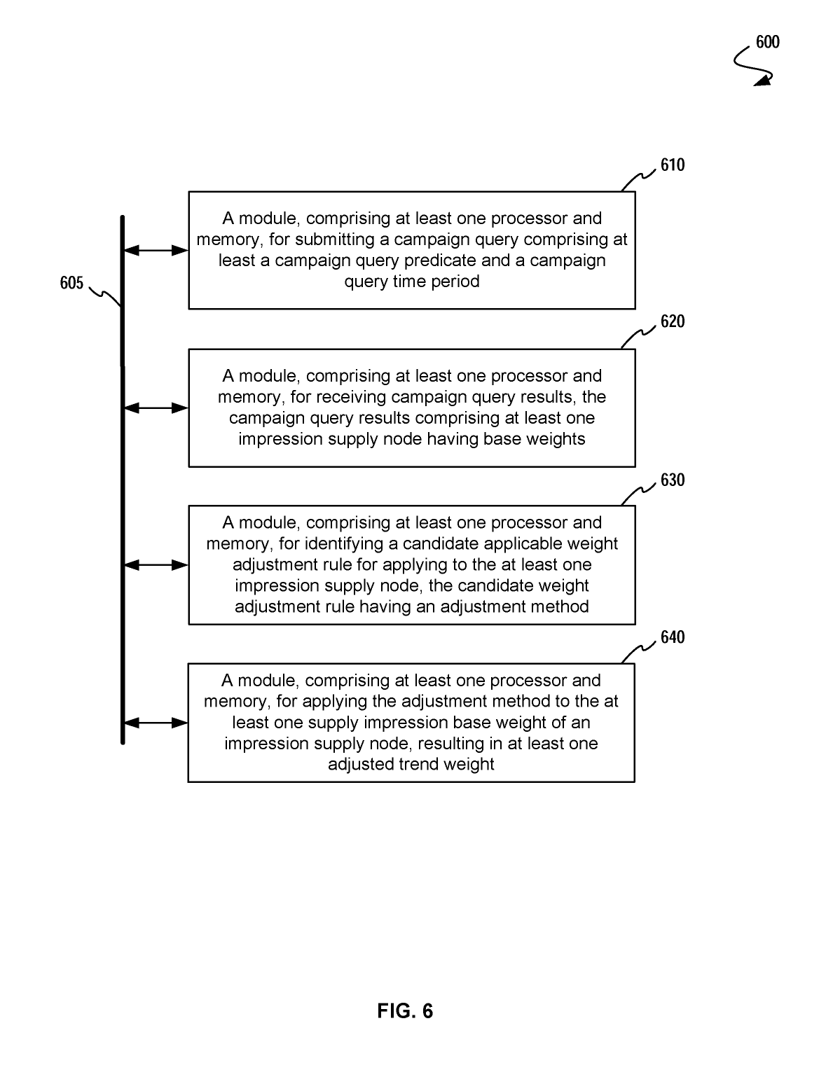

FIG. 6 depicts a block diagram of a system for adjusting impression supply inventory using a set of override rules in an advertising environment. As an option, the present system 600 may be implemented in the context of the architecture and functionality of the embodiments described herein. Of course, however, the system 600 or any operation therein may be carried out in any desired environment. As shown, system 600 comprises a plurality of modules, a module comprising at least one processor and a memory, each connected to a communication link 605, and any module can communicate with other modules over communication link 605. The modules of the system can, individually or in combination, perform method steps within system 600. Any method steps performed within system 600 may be performed in any order unless as may be specified in the claims. As shown, system 600 implements a method for adjusting impression supply inventory using a set of override rules in an advertising environment, the system 600 comprising modules for: submitting a campaign query comprising at least a campaign query predicate (see module 610); receiving initial campaign query results, the initial campaign query results comprising at least one impression supply node having base weights and creating an impression-to-rule index, the impression-to-rule index for determining if at least one weight adjustment rule selected from the set of override rules is applicable to the at least one impression supply node (see module 620); identifying, using the impression-to-rule index, a candidate applicable weight adjustment rule for applying to the at least one impression supply node, the candidate applicable weight adjustment rule having an adjustment method (see module 630); and applying the adjustment method to the at least one supply impression base weight of an impression supply node, resulting in at least one adjusted trend weight (see module 640).

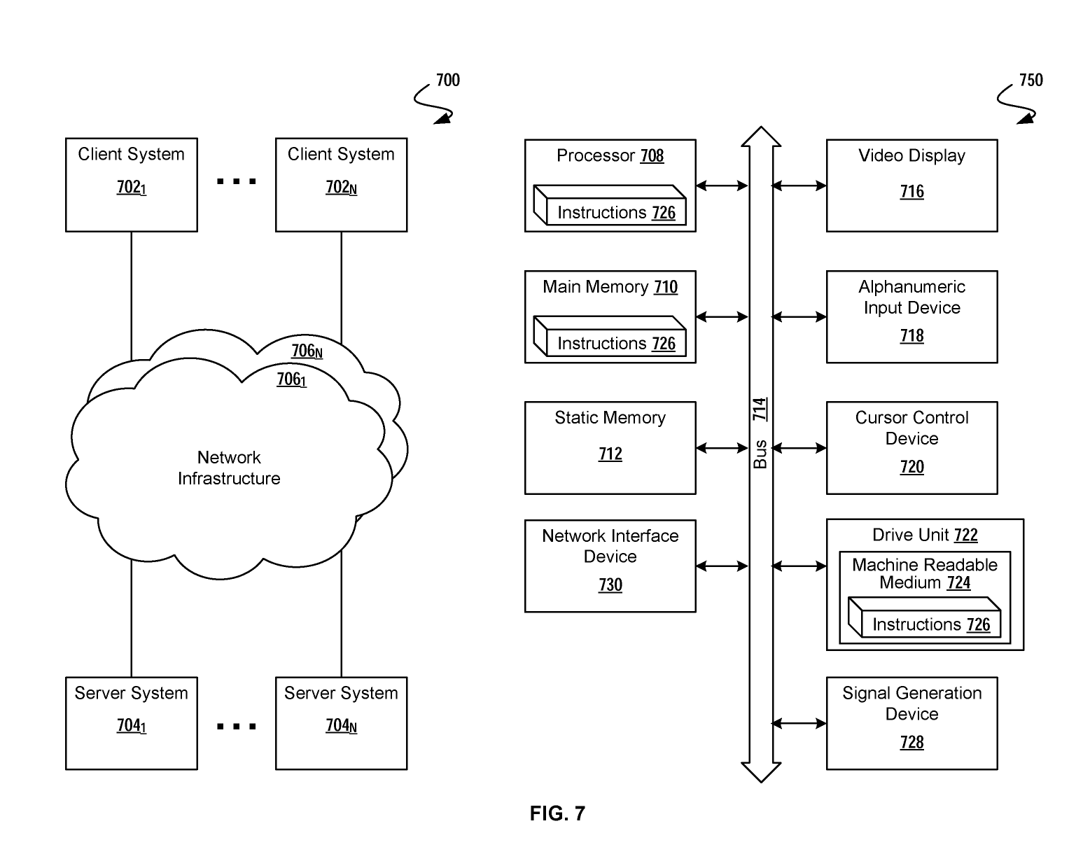

FIG. 7 is a diagrammatic representation of a network 700, including nodes for client computer systems 702₁ through 702_{N}, nodes for server computer systems 704₁ through 704_{N}, and network infrastructure nodes 706₁ through 706_{N}, according to some embodiments. The embodiment shown is purely exemplary, and might be implemented in the context of one or more of the figures herein.

Any node of the network 700 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system 750 includes a processor 708 (e.g. a processor core, a microprocessor, a computing device, etc), a main memory 710 and a static memory 712, which communicate with each other via a bus 714. The machine 750 may further include a display unit 716 that may comprise a touch-screen, or a liquid crystal display (LCD), or a light emitting diode (LED) display, or a cathode ray tube (CRT). As shown, the computer system 750 also includes a human input/output (I/O) device 718 (e.g. a keyboard, an alphanumeric keypad, etc), a pointing device 720 (e.g. a mouse, a touch screen, etc), a drive unit 722 (e.g. a disk drive unit, a CD/DVD drive, a tangible computer readable removable media drive, an SSD storage device, etc), a signal generation device 728 (e.g. a speaker, an audio output, etc), and a network interface device 730 (e.g. an Ethernet interface, a wired network interface, a wireless network interface, a propagated signal interface, etc).

The drive unit 722 includes a machine-readable medium 724 on which is stored a set of instructions (i.e. software, firmware, middleware, etc) 726 embodying any one, or all, of the methodologies described above. The set of instructions 726 is also shown to reside, completely or at least partially, within the main memory 710 and/or within the processor 708. The set of instructions 726 may further be transmitted or received via the network interface device 730 over the network bus 714.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing information in a form readable by a machine (e.g. a computer). For example, a machine-readable medium includes read-only memory (ROM); random access memory (RAM); magnetic disk storage media; optical storage media; flash memory devices; electrical, optical or acoustical or any other type of media suitable for storing information.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

We claim:

1. A computer-implemented method for adjusting impression supply inventory using a set of override rules in an advertising environment, comprising:
submitting, using a computer, a campaign query comprising at least a campaign query predicate;
receiving, at a computer, initial campaign query results, the initial campaign query results comprising at least one impression supply node base weight;
creating, in a computer memory, an impression-to-rule index, the impression-to-rule index for determining if at least one weight adjustment rule selected from the set of override rules is applicable to the at least one impression supply node;
identifying, using the impression-to-rule index, a candidate applicable weight adjustment rule for applying to the at least one impression supply node, the candidate applicable weight adjustment rule having an adjustment method; and
applying, in a computer memory, the adjustment method to the at least one supply impression base weight of an impression supply node, resulting in at least one adjusted trend weight.

2. The method of claim 1, further comprising sampling at least one impression supply node having at least one adjusted trend weight.

3. The method of claim 1, wherein the campaign query further comprises a campaign query time period.

4. The method of claim 1, further comprising:
creating a rule-to-supply index.

5. The method of claim 4, wherein the rule-to-supply index is for determining a set of impression supply nodes that are applicable to the least one weight adjustment rule selected from the set of override rules.

6. The method of claim 1, wherein the impression-to-rule index is recreated on a reoccurring schedule.

7. The method of claim 1, wherein the applying the adjustment method to the at least one supply impression base weight comprises calculating at least one adjusted trend weight using a projection of a time-wise adjustment method onto a time-wise base weight.

8. The method of claim 1, wherein the campaign query includes at least one of, a historical query, a future query.

9. An advertising server network for adjusting impression supply sampling weights in a display advertising environment, comprising:
a module for submitting a campaign query comprising at least a campaign query predicate;
a module for receiving initial campaign query results, the initial campaign query results comprising at least one impression supply node base weight;
a module for creating an impression-to-rule index, the impression-to-rule index for determining if at least one weight adjustment rule selected from the set of override rules is applicable to the at least one impression supply node;
a module for identifying, using the impression-to-rule index, a candidate applicable weight adjustment rule for applying to the at least one impression supply node, the candidate applicable weight adjustment rule having an adjustment method; and
a module for applying, in a computer memory, the adjustment method to the at least one supply impression base weight of an impression supply node, resulting in at least one adjusted trend weight.

10. The advertising server network of claim 9, further comprising sampling at least one impression supply node having at least one adjusted trend weight.

11. The advertising server network of claim 9, wherein the campaign query further comprises a campaign query time period.

12. The advertising server network of claim 9, further comprising:
creating a rule-to-supply index.

13. The advertising server network of claim 12, wherein the rule-to-supply index is for determining a set of impression supply nodes that are applicable to the least one weight adjustment rule selected from the set of override rules.

14. The advertising server network of claim 9, wherein the impression-to-rule index is recreated on a reoccurring schedule.

15. The advertising server network of claim 9, wherein the campaign query includes at least one of, a historical query, a future query.

16. A non-transitory computer readable medium comprising a set of instructions which, when executed by a computer, cause the computer to adjust impression supply inventory using a set of override rules in an advertising environment, the set of instructions for:
submitting a campaign query comprising at least a campaign query predicate;
receiving initial campaign query results, the initial campaign query results comprising at least one impression supply node base weight;
creating an impression-to-rule index, the impression-to-rule index for determining if at least one weight adjustment rule selected from the set of override rules is applicable to the at least one impression supply node;
identifying, using the impression-to-rule index, a candidate applicable weight adjustment rule for applying to the at least one impression supply node, the candidate applicable weight adjustment rule having an adjustment method; and
applying the adjustment method to the at least one supply impression base weight of an impression supply node, resulting in at least one adjusted trend weight.

17. The non-transitory computer readable medium of claim 16, further comprising sampling at least one impression supply node having at least one adjusted trend weight.

18. The non-transitory computer readable medium of claim 16, wherein the campaign query further comprises a campaign query time period.

19. The non-transitory computer readable medium of claim 16, further comprising:
creating a rule-to-supply index.

20. The non-transitory computer readable medium of claim 16, wherein the impression-to-rule index is recreated on a reoccurring schedule.
